(19) United States
(12) Patent Application Publication
(10) Pub. No.: US 2016/0173362 A1
(43) Pub. Date: Jun. 16, 2016

(54) DETECTING NICKNAME CONFLICT

(71) Applicant: HANGZHOU H3C TECHNOLOGIES CO., LTD., Hangzhou, Zhejiang (CN)

(72) Inventor: Jin QU, Beijing (CN)

(73) Assignee: Hangzhou H3C Technologies Co., Ltd., Hangzhou City (CN)

(21) Appl. No.: 14/891,877

(22) PCT Filed: May 20, 2014
(86) PCT No.: PCT/CN2014/077841

§ 371 Date: Nov. 17, 2015

(30) Foreign Application Priority Data
May 20, 2013 (CN) 201310187933.1

(51) Int. Cl. H04L 12/751; H04L 12/947; H04L 12/721

(52) U.S. Cl. CPC H04L 45/026; H04L 45/66; H04L 49/25

(57) ABSTRACT

After a RB in a TRILL network starts or establishes neighbor relationships with other RBs, the RB sends a nickname conflict detection packet. After receiving the packet, a DRB replies with a response packet carrying nickname information corresponding to all LSPs in the LSDB to the RB. The RB receives the response packet sent from the DRB, checks whether a nickname has a conflict with nicknames of other RBs and regenerates a nickname that is not conflict with the nicknames of other RBs.

### BACKGROUND

Transparent Interconnection of Lots of Links (TRILL) is a data link layer (layer 2) networking standard recommended by Internet Engineering Task Force (IETF). The TRILL technology is an innovative technology that changes the traditional way to build data center networks, it adopts network layer (layer 3) routing technology benefits, such as stable, scalable and high performance into an adaptable, but limited scope of layer 2 switching network, to establish a flexible, extensible, high-performance layer 2 network architecture. Users can use layer 2 switching devices adopting the TRILL technology to build a large, high-performance, scalable and supporting virtual machine live migration cloud data center network.

### BRIEF DESCRIPTION OF THE DRAWINGS

FIG. 1 is a flow chart of a method for detecting a nickname conflict in a TRILL network according to one example of the present disclosure;

FIG. 2 is another flow chart of a method for detecting a nickname conflict in a TRILL network according to one example of the present disclosure;

FIG. 3 is a schematic diagram showing a Value part of a nickname entry TLV according to one example of the present disclosure;

FIG. 4 is still another flow chart of a method for detecting a nickname conflict in a TRILL network according to one example of the present disclosure;

FIG. 5 is yet another flow chart of a method for detecting a nickname conflict in a TRILL network according to one example of the present disclosure;

FIG. 6 is still yet another flow chart of a method for detecting a nickname conflict in a TRILL network according to one example of the present disclosure;

FIG. 7 is a schematic diagram showing a RB in a TRILL network according to one example of the present disclosure;

FIG. 8 is a schematic diagram showing a DRB in a TRILL network according to one example of the present disclosure;

FIG. 9 is a schematic diagram showing a RB in a TRILL network according to one example of the present disclosure;

FIG. 10 is a schematic diagram showing a designated RB (DRB) in a TRILL network according to one example of the present disclosure.

### DETAILED DESCRIPTION

In the TRILL network, a nickname is used for routing of forwarded packets. When calculating routing table entries, a nickname of each routing bridge (RB) is used to calculate unicast and multicast routing table entries. The RB is a network device that implements the TRILL protocol. Each RB ensures its nickname is unique in the whole network. If a conflict occurs, the nickname is changed, and this may cause a recalculation of routing table entries. If the nickname is a multicast tree root, a large amount of recalculation of multicast routing table entries may be required. Changing a variety of routing table entries which are being used may further cause a temporary traffic interruption. Thus, there is a need to provide an effective method to avoid traffic oscillation when the nickname conflict occurs.

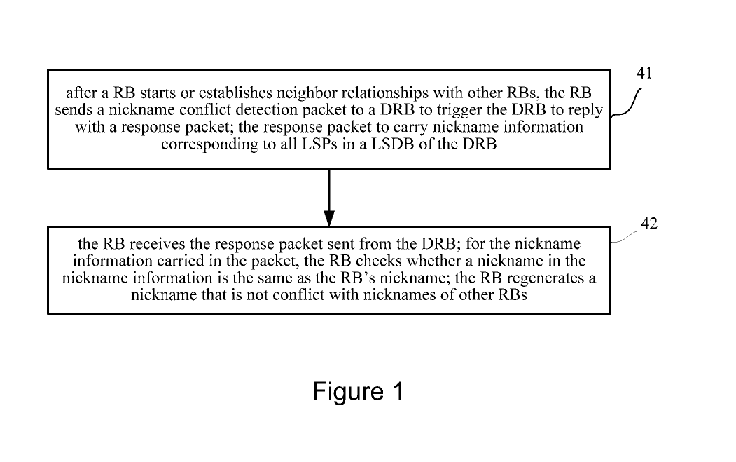

FIG. 1 is a flow chart of a method for detecting a nickname conflict in a TRILL network according to one example of the present disclosure. Referring to FIG. 1, the method includes the following blocks.

At block 41, after a RB in a TRILL network starts or establishes neighbor relationships with other RBs, the RB sends a nickname conflict detection packet to a designated RB (DRB) to trigger the DRB to reply with a response packet. The response packet carries nickname information corresponding to all link state packets (LSPs) in a link state database (LSDB) of the DRB. A LSP contains routing information data of a RB. Each RB has a link state database (LSDB) containing LSPs of all RBs in the whole network. For example, the response packet can carry nickname information corresponding to all LSPs in the LSDB of the DRB. Nickname information can include a nickname.

At block 42, the RB receives the response packet sent from the DRB. For the nickname information carried in the packet, the RB checks whether one of nicknames in the nickname information is the same as the RB's nickname. If one of the nicknames conflicts (e.g. matches) with the RB nickname, the RB regenerates a nickname which does not conflict with nicknames of other RBs.

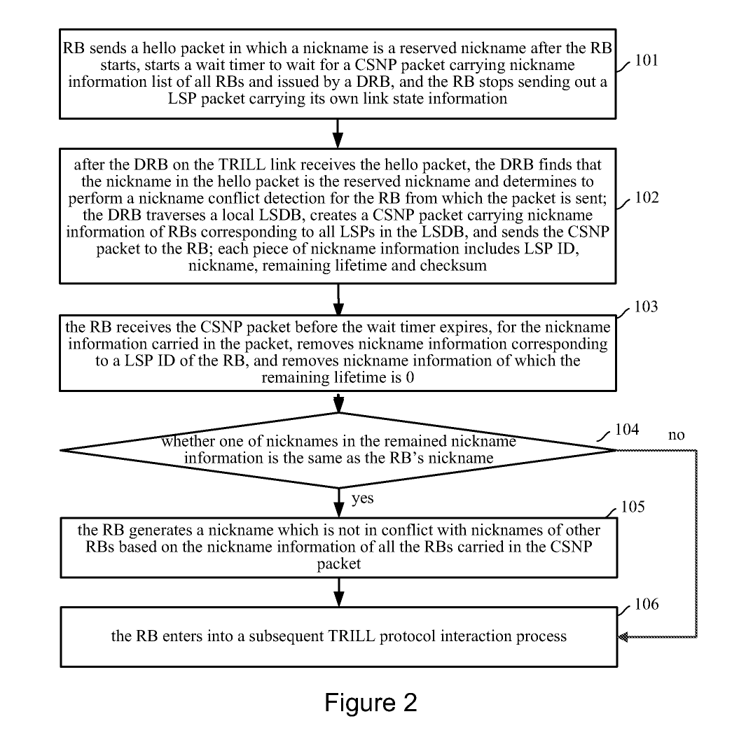

FIG. 2 is a flow chart of a method for detecting a nickname conflict in a TRILL network according to one example of the present disclosure. As shown in FIG. 2, the method further includes the following blocks.

At block 101, a RB sends a hello packet in which a nickname is a reserved nickname after the RB starts, starts a wait timer to wait for a complete sequence number packet data unit (CSNP) packet carrying nickname information of all RBs and issued by a DRB, and the RB stops sending out a LSP packet carrying the RB's link state information. Here, a hello packet in TRILL is a TRILL control packet which is used to discover neighbors on a link, interchange port capacities, establish and maintain adjacencies; a wait timer is used to limit a time period for receiving a keepalive packet or a response packet. In one example, the RB can send a hello packet immediately after the RB starts, start the wait timer, and simultaneously stop sending out the LSP packet carrying the RB's link state information.

An example of a reserved nickname is 0×0000.

The hello packet may carry a DRB election priority. The DRB election priority is used to elect a DRB. In example applications, the RB may further set the DRB election priority to be the lowest to prevent the RB from being elected as a DRB by other RBs on a link. For each RB, DRB election priorities of hello packets sent from all RBs on a same TRILL link are compared and a sender of a hello packet with the highest priority may be elected as a DRB.

At block 102, after the DRB on the TRILL link receives the hello packet, the DRB finds (e.g. identifies) that the nickname in the hello packet is the reserved nickname and determines to perform a nickname conflict detection for the RB from which the packet is sent. The DRB traverses a local LSDB, creates a CSNP packet carrying nickname information of RBs corresponding to all LSPs in the LSDB, and sends the CSNP packet to the RB. Each piece of the nickname information includes LSP ID, nickname, remaining lifetime and checksum.

Here, similar to a current LSP entry type-length-value (TLV) carried in a CSNP packet data unit (PDU), one example of the present disclosure defines a new nickname entry TLV so as to carry the nickname information of all the RBs in the whole network recognized by the DRB in a last variable length part of the CSNP PDU, i.e., the nickname entry TLV records the nickname information of each RB corresponding to each LSP in the LSDB. Specific meanings of each part of the nickname entry TLV are as follows.

1) Type is to identify the TLV to be a nickname entry TLV, for example, a possible value can be 65.

2) Length is to show a variable length part of the nickname entry TLV, i.e., a total length of the value part.

3) Value is a nickname information list of all RBs.

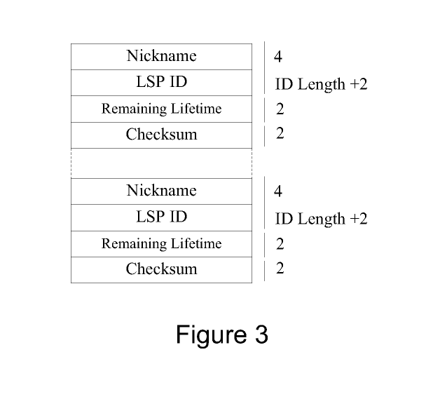

FIG. 3 is a schematic diagram showing a Value part of a nickname entry TLV of a CSNP PDU according to one example of the present disclosure. As shown in FIG. 3, for each RB, the nickname information is composed of four parts which are described as follows.

1) Nickname is a nickname of a RB corresponding to a LSP in the LSDB of the DRB.

2) LSP ID is an identifier of the LSP. For example, the first six bytes of the LSP ID are a system ID of a RB which sends the LSP.

3) Remaining lifetime means a period of time left for the LSP before expiring.

4) Checksum is a checksum of the LSP.

In the nickname entry TLV, all nickname entries can be arranged from small to large according to a nickname lexicographic order.

At block 103, the RB receives the CSNP packet before the wait timer expires. For the nickname information of the RBs carried in the packet, the RB removes nickname information corresponding to a LSP ID of the RB and removes nickname information of which the remaining lifetime is 0.

If the RB does not receive the CSNP packet carrying the nickname information of all the RBs and issued by the DRB when the timer expires, the RB determines the RB's nickname has no conflict and enters into a subsequent TRILL protocol interaction process, such as beginning to send out a LSP packet carrying the RB's link state information.

At block 104, the RB compares whether one of nicknames in the remained nickname information is the same as the RB's nickname. Block 105 is performed when the RB's nickname is in the nickname information and Block 106 is performed when the RB's nickname is not in the nickname information.

At block 105, the RB generates a nickname which is not in conflict with nicknames of other RBs based on the nickname information of the RBs carried in the CSNP packet.

At block 106, the RB enters into the subsequent TRILL protocol interaction process. For example, beginning to send out the LSP packet carrying the RB's link state information.

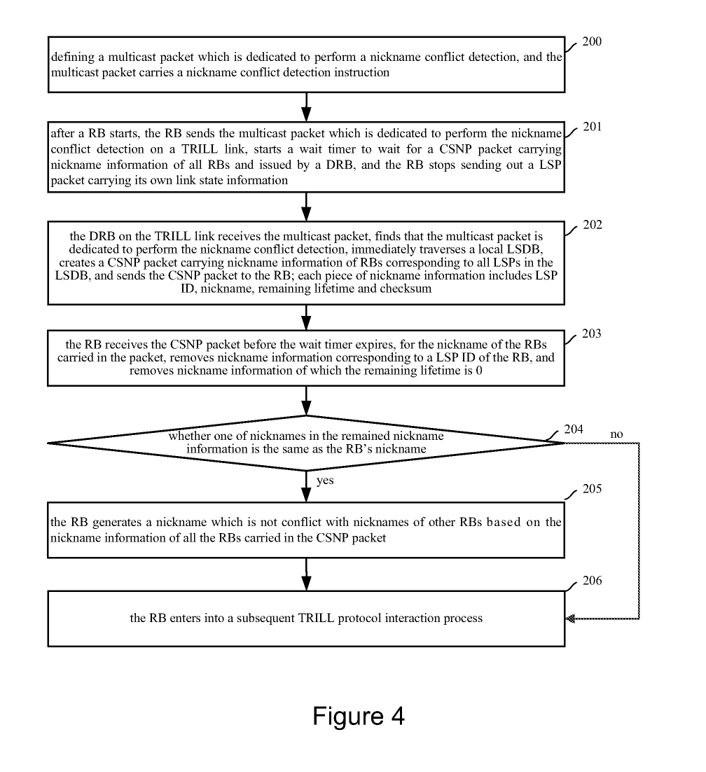

FIG. 4 is still another flow chart of a method for detecting a nickname conflict in a TRILL network according to one example of the present disclosure. As shown in FIG. 4, the method includes following blocks.

At block 200, defining a multicast packet which is dedicated to perform a nickname conflict detection. The multicast packet carries a nickname conflict detection instruction. For example, a nickname conflict detection instruction can be an instruction to set a nickname in the multicast packet to be a reserved nickname.

At block 201, after a RB starts, the RB sends the multicast packet which is dedicated to perform the nickname conflict detection on a TRILL link, starts a wait timer to wait for a CSNP packet carrying nickname information of all RBs and issued by a DRB, and the RB stops sending out a LSP packet carrying the RB's link state information.

At block 202, the DRB on the TRILL link receives the multicast packet, finds that the multicast packet is dedicated to perform the nickname conflict detection, immediately traverses a local LSDB, creates a CSNP packet carrying nickname information of RBs corresponding to all LSPs in the LSDB, and sends the CSNP packet to the RB. Each piece of the nickname information includes LSP ID, nickname, remaining lifetime and checksum.

A format of the CSNP packet in this block is the same as that in the block 102 of FIG. 2.

After other RBs on the TRILL link (except for the DRB) receive the multicast packet, the other RBs do not perform further processing.

Blocks 203, 204, 205 and 206 are the same as the blocks 103, 104, 105, and 106 of FIG. 2, respectively.

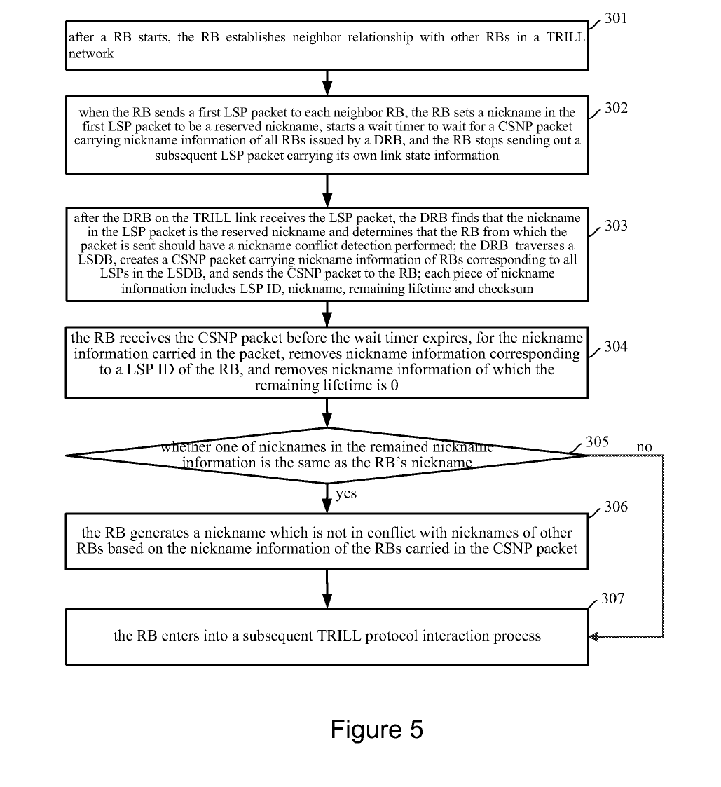

FIG. 5 is yet another flow chart of a method for detecting a nickname conflict in a TRILL network according to one example of the present disclosure. As shown in FIG. 5, the method includes following blocks.

At block 301, after a RB starts, the RB establishes neighbor relationships with other RBs in a TRILL network. For example, the RB can establish neighbor relationships by sending a broadcasts control message or a hello packet to neighbor devices.

At block 302: when the RB sends a first LSP packet to each neighbor RB, the RB sets a nickname in the first LSP packet to be a reserved nickname, starts a wait timer to wait for a CSNP packet carrying nickname information of all RBs issued by a DRB, and the RB stops sending out a subsequent LSP packet carrying the RB's link state information.

As mentioned above, the reserved nickname can be set to 0×0000.

At block 303: after the DRB on the TRILL link receives the LSP packet, the DRB finds that the nickname in the LSP packet is the reserved nickname and determines that the RB from which the packet is sent should have a nickname conflict detection performed. For example, a match between the nickname in the LSP packet and the reserved nickname can indicate a nickname conflict detection should be performed on the RB. The DRB traverses a LSDB, creates a CSNP packet carrying nickname information of RBs corresponding to all LSPs in the LSDB, and sends the CSNP packet to the RB. Each piece of the nickname information includes LSP ID, nickname, remaining lifetime and checksum.

In this block, after the DRB finds that the nickname in the LSP packet is the reserved nickname, the DRB does not place link state information of the LSP packet into the local LSDB. Similarly, after other RBs receive the LSP packet and find that the nickname in the LSP packet is the reserved nickname, other RBs also do not place the link state information in the LSP packet into the local LSDB.

A format of the CSNP packet in this block is the same as that in the block 102 of FIG. 2.

Blocks 304, 305, 306, and 307 are the same as the blocks 103, 104, 105, and 106 of FIG. 2, respectively.

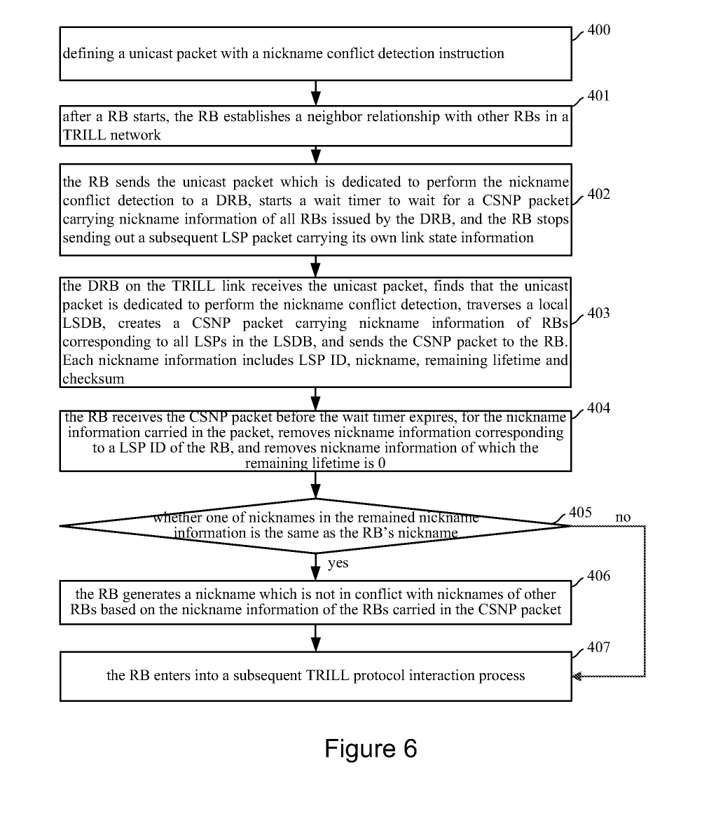

FIG. 6 is still another flow chart of a method for detecting a nickname conflict in a TRILL network according to one example of the present disclosure. As shown in FIG. 6, the method includes following blocks.

At block 400, defining a unicast packet (such as a unicast packet that is dedicated to perform a nickname conflict detection) with a nickname conflict detection instruction. For example, the unicast packet can include an instruction to set a nickname in the unicast packet to be a reserved nickname.

At block 401, after a RB starts, the RB establishes neighbor relationships with other RBs in a TRILL network.

At block 402, the RB sends the unicast packet which is dedicated to perform the nickname conflict detection to a DRB, starts a wait timer to wait for a CSNP packet carrying nickname information of all RBs and issued by the DRB, and the RB stops sending out a subsequent LSP packet carrying the RB's link state information.

At block 403: the DRB on the TRILL link receives the unicast packet, finds that the unicast packet is dedicated to perform the nickname conflict detection, traverses a local LSDB, creates a CSNP packet carrying nickname information of RBs corresponding to all LSPs in the LSDB, and sends the CSNP packet to the RB. Each piece of the nickname information includes LSP ID, nickname, remaining lifetime and checksum.

A format of the CSNP packet in this block is the same as that in the block 102 of FIG. 2.

Blocks 404, 405, 406, and 407 are the same as the blocks 103, 104, 105, and 106 of FIG. 2, respectively.

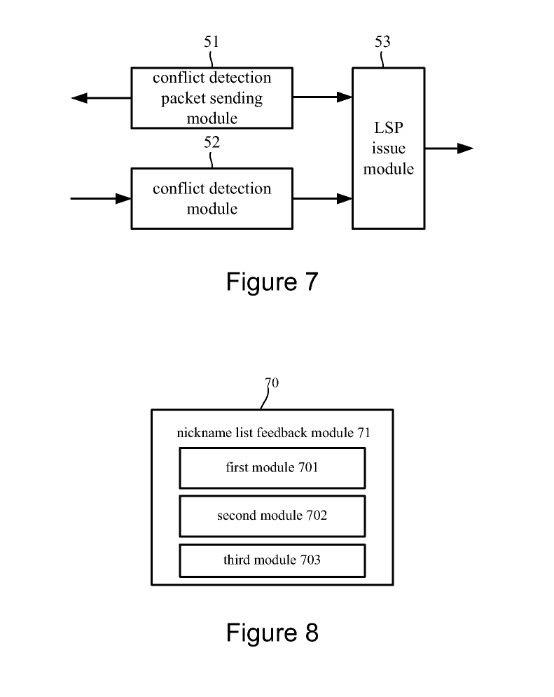

FIG. 7 is a schematic diagram showing a RB in a TRILL network according to one example of the present disclosure. As shown in FIG. 7, the RB includes a conflict detection packet sending module 51, a conflict detection module 52 and a LSP issue module 53.

The conflict detection packet sending module 51 represents program instructions that when executed by a processor perform, after the RB starts or establishes neighbor relationships with other RBs, sending a nickname conflict detection packet, and sending a stop instruction to the LSP issue module 53.

The nickname conflict detection packet which is sent after the RB starts is a hello packet which carries a nickname conflict detection instruction or a multicast packet which is dedicated to perform a nickname conflict detection. An example nickname conflict detection instruction in the packet can be: nickname in the packet=reserved nickname.

The nickname conflict detection packet which is sent after the RB establishes neighbor relationships with other RBs is a first LSP packet which is sent after the RB establishes neighbor relationships with other RBs and carries a nickname conflict detection instruction. Alternatively, the nickname conflict detection packet which is sent after the RB establishes neighbor relationships with other RBs is a unicast packet which is dedicated to perform a nickname conflict detection and sent to the DRB. An example nickname conflict detection instruction in the packet can be: nickname in the packet=reserved nickname.

The conflict detection packet sending module 51 is further to set a DRB election priority in the hello packet to be the lowest.

The conflict detection module 52 represents program instructions that when executed by a processor perform, receiving a nickname conflict detection response packet sent from the DRB. The nickname conflict detection response packet carries nickname information corresponding to all LSPs in a LSDB of the DRB. The nickname information includes nickname, LSP ID and remaining lifetime. For all the nickname information carried in the nickname conflict detection response packet, the conflict detection module 52 is to remove nickname information corresponding to a LSP ID of the RB, and remove nickname information of which the remaining lifetime is 0, and then check whether one of nicknames in the remained nickname information is the same as the RB's nickname. If the conflicting nickname remains in the nickname information, regenerate a nickname which is not conflict with nicknames of other RBs and send a beginning instruction to the LSP issue module 53, otherwise, directly send a beginning instruction to the LSP issue module 53.

The LSP issue module 53 represents program instructions that when executed by a processor perform sending out a LSP packet carrying link state information of the local RB. When receiving the stop instruction sent from the conflict detection packet sending module 51, the LSP issue module 53 is to stop sending the LSP packet. When receiving the beginning instruction sent from the conflict detection module 52, the LSP issue module 53 is to restart to send out the LSP packet.

In actual applications, the RB can further include a timer, such as the wait timer discussed herein. The timer is to start timing when receiving a start instruction and stop timing when a timing length is reached.

The conflict detection packet sending module 51 is further to, when sending the nickname conflict detection packet, set the timing length of the above timer and send the start instruction to the above timer.

The conflict detection module 52 is further to, when finding that it does not receive the nickname conflict detection response packet carrying nickname information corresponding to all the LSPs and sent from the DRB when the above timer expires, determine that the nickname of the RB has no conflict and send the beginning instruction to the LSP issue module 53.

FIG. 8 is a schematic diagram showing a DRB in a TRILL network according to one example of the present disclosure. As shown in FIG. 8, the DRB 70 includes a nickname list feedback module 71. The nickname list feedback module 71 further includes a first module 701, a second module 702 and a third module 703. The first module 701 represents program instructions that when executed by a processor perform receiving a nickname conflict detection packet sent from a RB. The second module 702 represents program instructions that when executed by a processor perform traversing a local LSDB. The third module 703 represents program instructions that when executed by a processor perform sending a nickname conflict detection response packet carrying nickname information corresponding to all LSPs in the LSDB to the RB. The nickname information includes nickname, LSP ID and remaining lifetime.

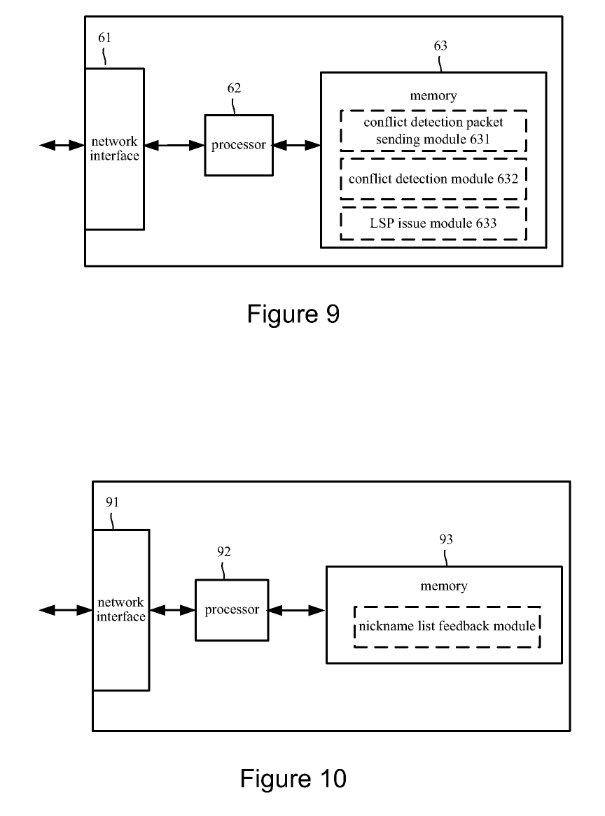

FIG. 9 is a schematic diagram showing a RB in a TRILL network according to one example of the present disclosure. As shown in FIG. 9, the RB includes a network interface 61, a processor 62 and a memory 63.

The network interface 61 is to send out a nickname conflict detection packet and receive a nickname conflict detection response packet sent from a DRB.

The processor 62 is to communicate with the memory 63 to execute computer program codes stored in the memory 63.

The memory 63 is to store the computer program codes including a conflict detection packet sending module 631, a conflict detection module 632 and a LSP issue module 633. The processor 62 executes the conflict detection packet sending module 631, the conflict detection module 632 and the LSP issue module 633 to perform: after a RB starts or establishes neighbor relationships with other RBs, sending a nickname conflict detection packet so as to trigger a DRB to traverse a local LSDB after the DRB receives the packet and trigger the DRB to send a response packet carrying nickname information corresponding to all LSPs in the LSDB to the RB; receiving the response packet sent from the DRB; for all the nickname information carried in the packet, checking whether one of nicknames in all the nickname information is the same as the RB's nickname; if yes, regenerating a nickname for the RB which is not conflict with nicknames of other RBs.

The sending a nickname conflict detection packet after the RB starts can include sending a hello packet carrying a nickname conflict detection instruction or sending a multicast packet which is dedicated to perform a nickname conflict detection.

The sending the nickname conflict detection packet after the RB establishes neighbor relationships with other RBs can include sending a first LSP packet carrying a nickname conflict detection instruction or sending a unicast packet which is dedicated to perform a nickname conflict detection to the DRB.

The nickname conflict detection instruction can be an instruction to make a nickname in the packet a reserved nickname.

The memory 63 is further to store computer program codes to complete following: starting a wait timer at the time of sending the nickname conflict detection packet, and stopping sending out a LSP packet carrying link state information of the local RB; if receiving a response packet sent from the DRB before the wait timer expires, beginning to send out the LSP packet carrying the link state information of the local RB after regenerating a nickname for the RB which is not conflict with nicknames of other RBs; if not receiving a response packet carrying the nickname information corresponding to all the LSPs and sent from the DRB when the wait timer expires, determining that the RB's nickname has no conflict and directly beginning to send out the LSP packet carrying the RB's link state information.

The memory 63 is further to store computer program codes to complete following: at the time of checking whether one of nicknames in all the nickname information is the same as the RB's nickname, for the nickname information carried in the response packet, removing nickname information corresponding to a LSP ID of the RB, and removing nickname information of which the remaining lifetime is 0, and then checking whether one of nicknames in the remained nickname information is the same as the RB's nickname.

FIG. 10 is a schematic diagram showing a DRB in a TRILL network according to one example of the present disclosure. As shown in FIG. 10, the DRB includes a network interface 91, a processor 92 and a memory 93.

The network interface 91 is to receive a nickname conflict detection packet sent from a RB, and send a nickname conflict detection response packet to the RB.

The processor 92 is to communication with the memory 93 to execute computer program codes stored in the memory 93.

The memory 93 is to store the computer program codes including a nickname list feedback module. The processor 92 executes the codes to complete blocks: when receiving a nickname conflict detection packet sent from the RB, traversing a local LSDB, and sending the response packet carrying nickname information corresponding to all LSPs in the LSDB to the RB.

The memory of one example of the present disclosure may include floppy disk, hard drive, magneto-optical disk, compact disk (such as CD-ROM, CD-R, CD-RW, DVD-ROM, DVD-RAM, DVD-RW, DVD+RW), magnetic tape drive, non-transitory memory card and ROM.

The foregoing are only preferred examples of the present disclosure, and are not used to limit the present disclosure. Any modification, equivalent replacement, or improvement made without departing from the spirit and principle of the present disclosure should fall within the scope of the present disclosure.

What is claimed is:

1. A method for detecting a nickname conflict comprising:
after a routing bridge (RB) in a transparent interconnection of lots of links (TRILL) network starts or establishes neighbor relationships with other RBs, sending by the RB a nickname conflict detection packet to a designated RB (DRB) to trigger the DRB to reply with a response packet, the response packet to carry nickname information corresponding to all link state packets (LSPs) in a link state database (LSDB) of the DRB;
receiving by the RB the response packet sent from the DRB;
for the nickname information carried in the response packet, checking whether a nickname in the nickname information is the same as the RB's nickname; and
regenerating by the RB a nickname that is not conflict with nicknames of other RBs.

2. The method of claim 1, wherein, sending by the RB the nickname conflict detection packet after the RB in the TRILL network starts comprises:
sending by the RB a hello packet carrying a nickname conflict detection instruction after the RB starts.

3. The method of claim 1, wherein, sending by the RB the nickname conflict detection packet after the RB in the TRILL network starts comprises:
sending by the RB a multicast packet which is dedicated to perform a nickname conflict detection after the RB starts.

4. The method of claim 1, wherein sending by the RB the nickname conflict detection packet after the RB in the TRILL network establishes neighbor relationships with other RBs comprises:
sending by the RB a first LSP packet carrying a nickname conflict detection instruction after the RB establishes neighbor relationships with other RBs.

5. The method of claim 1, wherein sending by the RB the nickname conflict detection packet after the RB in the TRILL network establishes neighbor relationships with other RBs comprises:
sending a unicast packet which is dedicated to perform a nickname conflict detection to the DRB after the RB establishes neighbor relationships with other RBs.

6. The method of claim 2, wherein the nickname conflict detection instruction is that a nickname in the packet is a reserved nickname.

7. The method of claim 1, wherein at the time of sending by the RB the nickname conflict detection packet, the method further comprises:
starting by the RB a wait timer; and
stopping sending out a LSP packet carrying the RB's link state information;
wherein receiving by the RB the response packet sent from the DRB comprises:
receiving by the RB the response packet sent from the DRB before the wait timer expires,
wherein after the regenerating by the RB a nickname which is not conflict with nicknames of other RBs, the method further comprises:
beginning by the RB to send out the LSP packet carrying the RB's link state information; and
wherein after the sending by the RB a nickname conflict detection packet, the method further comprises:
if the RB does not receive the response packet carrying the nickname information corresponding to the LSP sent from the DRB when the timer expires, determining by the RB its own nickname has no conflict and directly beginning to send out the LSP carrying the RB's link state information.

8. The method of claim 1, wherein:
the nickname information comprises plurality of nicknames, each nickname of the plurality of nicknames associated with a LSP identifier (ID) and a remaining lifetime;
the checking whether a nickname in the nickname information is the same as the RB's nickname comprises, for each of the plurality of nicknames carried in the response packet:
removing nickname information corresponding to a LSP ID of the RB;
removing nickname information of which the remaining lifetime is 0; and
checking whether the nickname in the remained nickname information is the same as the RB's nickname.

9. A routing bridge (RB) in a transparent interconnection of lots of links (TRILL) network comprising:
a conflict detection packet sending module to send a nickname conflict detection packet after the RB starts or establishes neighbor relationships with other RBs;
a conflict detection module to:
receive a nickname conflict detection response packet sent from a designated RB (DRB), the nickname conflict detection response packet to carry nickname information corresponding to all LSPs in a link state database (LSDB) of the DRB;
for all the nickname information carried in the nickname conflict detection response packet, check whether one of a plurality of nicknames in the nickname information is the same as the RB's nickname; and
when the one of the plurality of nicknames matches the RB's nickname, regenerate a nickname that is not conflict with nicknames of other RBs.

10. The RB of claim 9, wherein the conflict detection packet sending module is to:
send a hello packet carrying a nickname conflict detection instruction after the conflict detection packet sending module starts; or
send a multicast packet which is dedicated to perform a nickname conflict detection after the conflict detection packet sending module starts.

11. The RB of claim 9, wherein the conflict detection packet sending module is to:
send a first LSP packet carrying a nickname conflict detection instruction after the RB establishes neighbor relationships with other RBs; or
send a unicast packet which is dedicated to perform a nickname conflict detection to the DRB after the RB establishes neighbor relationships with other RBs.

12. The RB of claim 9, wherein the conflict detection packet sending module is further to set a nickname in the nickname conflict detection packet to be a reserved nickname.

13. The RB of claim 9, wherein the RB further comprises:
a timer to start timing when receiving a start instruction and stop timing when a timing length is reached;
a LSP issue module to:
send out a LSP packet carrying link state information of the RB;
when receiving a stop instruction, stop sending the LSP packet; and
when receiving a beginning instruction, restart to send out the LSP packet;
wherein the conflict detection packet sending module is further to:
when sending the nickname conflict detection packet:
set the timing length of the timer;
send the start instruction to the timer; and
simultaneously send the stop instruction to the LSP issue module; and
send the beginning instruction to the LSP issue module after regenerating a nickname for the RB which is not conflict with nicknames of other RBs.

14. The RB of claim 9, wherein the conflict detection module is further to, for the nickname information carried in the nickname conflict detection response packet:
remove nickname information corresponding to a LSP ID of the RB;
remove nickname information of which the remaining lifetime is 0; and
check whether one of nicknames in the remained nickname information is the same as the RB's nickname.

15. A designated routing bridge (DRB) in a transparent interconnection of lots of links (TRILL) network, comprising:
a nickname list feedback module, wherein the nickname list feedback module comprises:
a first module to receive a nickname conflict detection packet sent from a RB;
a second module to traverse a local link state database (LSDB); and
a third module to send a response packet carrying nickname information corresponding to all LSPs of the LSDB to the RB.
